(19) United States
(12) Patent Application Publication
(10) Pub. No.: US 2013/0191661 A1
(43) Pub. Date: Jul. 25, 2013

(54) EXTERNAL ELECTRONIC DEVICE

(71) Applicants: Hsin-Ting Liu, New Taipei City (TW); Chun-Hung Chen, New Taipei City (TW); Ming-Jen Lin, New Taipei City (TW)

(72) Inventors: Hsin-Ting Liu, New Taipei City (TW); Chun-Hung Chen, New Taipei City (TW); Ming-Jen Lin, New Taipei City (TW)

(73) Assignee: ASMedia Technology Inc., New Taipei City (TW)

(21) Appl. No.: 13/739,006

(22) Filed: Jan. 11, 2013

(30) Foreign Application Priority Data
Jan. 19, 2012 (TW) 101102225

(51) Int. Cl. G06F 1/26

(52) U.S. Cl. CPC G06F 1/26
USPC 713/310

(57) ABSTRACT

An external electronic device connected to an electronic device which includes a first transmission interface is provided. The external electronic device includes a power control module, a data control module, a second transmission interface and a switch module. The power control module receives an external power. The second transmission interface corresponds to the first transmission interface. The switch module controls the second transmission interface to electrically connect to the power control module or the data control module, and thus the external electronic device enters a power mode or a transfer mode.

### CROSS-REFERENCE TO RELATED APPLICATION

This application claims the priority benefit of Taiwan application serial No. 101102225, filed on Jan. 19, 2012. The entirety of the above-mentioned patent application is hereby incorporated by reference herein and made a part of specification.

### BACKGROUND OF THE INVENTION

1. Field of the Invention

The invention relates to an electronic device and, more particularly, to an external electronic device which can charge a portable electronic device.

2. Description of the Related Art

With information explosion, people send and receive various electrical files every day, such as texts, pictures, sound, media files and updating software. Since the files are too many and occupy much space, users usually take an external hard disk as a portable storage device to store the files. The users may also use an external optical disk drive to record the files in the disk and play the files on a computer. Consequently, the external hard disk and the external optical disk drive become common devices in information life.

FIG. 1 is a schematic diagram showing a conventional hard disk. Please refer to FIG. 1, an external hard disk in 3.5 inches is taken as an example, the conventional external hard disk 100 includes a data controller 110, a hard disk 120 and a transmission interface 130. The external power S provides power to the conventional external hard disk 100, and the data controller 110 is electrically connected between the hard disk 120 and the transmission interface 130. When the external hard disk 100 in FIG. 1 is connected to a computer via the transmission interface 130, the computer can access the hard disk 120.

Moreover, as science technology develops, more and more portable electronic devices, such as a tablet or a mobile phone, with a built-in battery are produced. The portable electronic device with a built-in battery can be charged via a customized charger or connected to a computer. However, if the user forgets to bring the customized charger or has no computer nearby to connect, the portable electronic device with a built-in battery cannot be charged.

### BRIEF SUMMARY OF THE INVENTION

An external electronic device connected to an electronic device which includes a first transmission interface is disclosed. The external electronic device includes a power control module, a data control module, a second transmission interface and a switch module. The power control module receives an external power. The switch module controls the second transmission interface to be electrically connected to the power control module or the data control module selectively, and switches the external electronic device at a power mode or a transfer mode with the electronic device.

These and other features, aspects and advantages of the present disclosure will become better understood with regard to the following description, appended claims, and accompanying drawings.

### BRIEF DESCRIPTION OF THE DRAWINGS

FIG. 1 is a schematic diagram showing a conventional hard disk;

FIG. 2 is a schematic diagram showing an external electronic device is working at a transfer mode in an embodiment; and

FIG. 3 is a schematic diagram showing an external electronic device is working at a power mode in an embodiment.

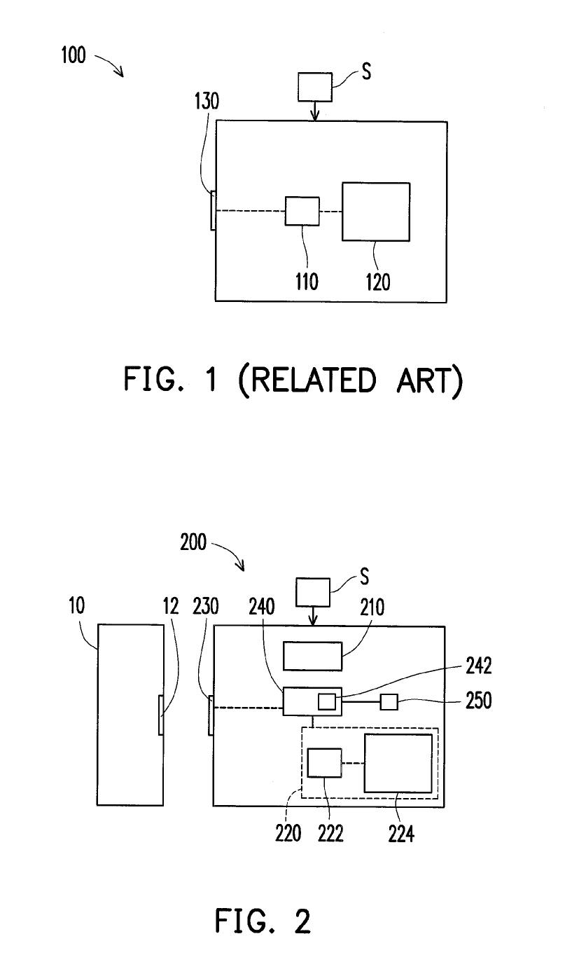

### DETAILED DESCRIPTION OF THE EMBODIMENTS

FIG. 2 is a schematic diagram showing an external electronic device is working at a transfer mode in an embodiment. Please refer to FIG. 2. The external electronic device 200 is connected to an electronic device 10. The electronic device 10 includes a first transmission interface 12. The electronic device 10 in FIG. 2 is a computer as an example. The external electronic device 200 may be an external hard disk, an external optical disk drive or a video recorder. In the embodiment, the external electronic device 200 is an external hard disk.

The external electronic device 200 includes a power control module 210, a data control module 220, a second transmission interface 230, a switch module 240 and a state display 250. The power control module 210 and the data control module 220 are connected to an external power S (such as electric supply or a battery). The data control module 220 includes a controller 222 and a hard disk 224, and the controller 222 is electrically connected to the hard disk 224.

The second transmission interface 230 of the external electronic device 200 is connected to the first transmission interface 12 of the electronic device 10 correspondingly. In the embodiment, the first transmission interface 12 and the second transmission interface 230 are universal serial bus (USB) interfaces. The first transmission interface 12 and the second transmission interface 230 may also be institute of electrical and electronic engineers (IEEE) interfaces, which is not limited herein.

The switch module 240 controls the second transmission interface 230 to electrically connect to the power control module 210 or the data control module 220 selectively, and makes the external electronic device 200 to execute a power mode or a transfer mode to the electronic device 10. The switch module 240 may include a switch 242, and the user can adjust the switch module 240 is working at the power mode or the transfer mode manually. The switch module 240 may also be adjusted by electrical signals to switch the external electronic device 200 is working at the power mode or the transfer mode.

The state display 250 is a light emitting element, such as a light-emitting diode (LED), electrically connected to the switch module 240. The state display 250 may give out light in different colors to indicate that the external electronic device 200 is working at the power mode or the transfer mode. The state display 250 may also flash at different intervals to indicate different modes. In other embodiments, two light emitting elements may be used to indicate the power mode and the transfer mode of the external electronic device 200, respectively. The state display 250 may indicate the user in different ways, such as sound control as long as it can notice users, which is not limited herein.

As shown in FIG. 2, when the external electronic device 200 is switched to the transfer mode, the switch module 240 is adjusted to make the second transmission interface 230 electrically connected to the data control module 220. At the transfer mode, the external electronic device 200 is connected to the electronic device 10 (such as a computer) via the second transmission interface 230 and the first transmission interface 12, and thus the computer can access the hard disk 224 of the external electronic device 200.

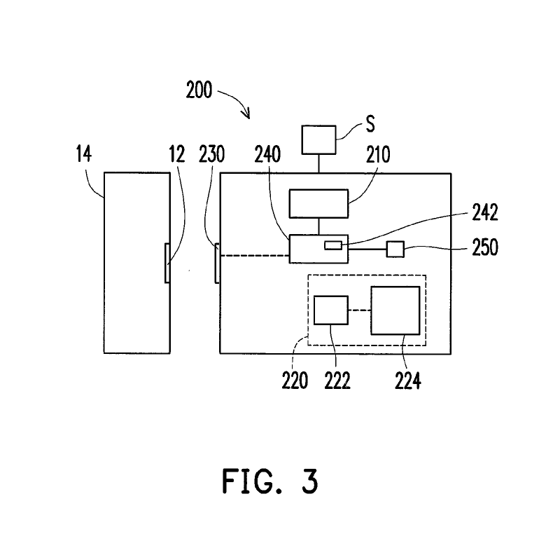

FIG. 3 is a schematic diagram showing an external electronic device at a power mode in an embodiment. Please refer to FIG. 3, when the external electronic device 200 is switched to the power mode, the switch module 240 is adjusted to make the second transmission interface 230 electrically connected to the power control module 210. At the power mode, the portable electronic device 14 with a built-in battery, such as a mobile phone or a tablet computer, is connected to the external electronic device 200 via the first transmission interface 12 and the second transmission interface 230, and the external electronic device 200 charges the battery built in the electronic device 14.

The power control module 210 can adjust the power mode to charge the portable electronic device 14 in different charging specifications according to a received power of the second transmission interface 230. A conventional portable electronic device 14 with a built-in battery may have many charging specifications. For example, a portable electronic device can be charged as long as the external electronic device can provide a 5V voltage. A handheld product is charged when the D+ line of a USB is at 2.7V and the D− line is at 2.1V, and charging information is displayed at a screen. A mobile phone may also use an USB-IF battery charging specification. The current version of USB-IF battery charging specification is version 1.2 and it includes determining whether the mobile phone can be charged according to a time lag of pulse voltages sent by the D+ line and the D− line. The version of USB-IF battery charging specification of the power control module 210 is not limited herein.

When a charging device meets a charging specification, it can charge the portable electronic device 14 with a built-in battery. In the embodiment, the power control module 210 meets charging specification of the USB D+ line and D− line and the USB-IF battery charging specification. The power control module 210 adjusts the charging specification to charge the portable electronic device 14 according to a received power of the second transmission interface 230. Moreover, when the external electronic device 200 is working at the power mode, the hard disk 224 of the data control module 220 is working at a standby mode to protect the hard disk 224 and reduce power consumption.

In sum, the external electronic device electrically connects the second transmission interface to the power control module or the data control module via the switch module to enter the power mode or the transfer mode. When the external electronic device is working at the transfer mode, the computer can be connected to it and access the external electronic device. When the external electronic device is working at the power mode, it can be connected to the portable electronic device with a built-in battery to provide power. Except for original functions, the external electronic device further provides a charging function to the portable electronic device. Additionally, the power control module of the external electronic device meets multiple charging specifications of the portable electronic device and has a good compatibility.

Although the present disclosure has been described in considerable detail with reference to certain preferred embodiments thereof, the disclosure is not for limiting the scope. Persons having ordinary skill in the art may make various modifications and changes without departing from the scope. Therefore, the scope of the appended claims should not be limited to the description of the preferred embodiments described above.

What is claimed is:

1. An external electronic device connected to an electronic device which includes a first transmission interface, the external electronic device comprising:
a power control module receiving an external power;
a data control module;
a second transmission interface; and
a switch module controlling the second transmission interface to be electrically connected to the power control module or the data control module selectively, and switching the external electronic device is working at a power mode or a transfer mode with the electronic device.

2. The external electronic device according to claim 1, wherein the external electronic device is an external hard disk, an external optical disk drive or a video recorder.

3. The external electronic device according to claim 1, wherein the electronic device is a mobile phone or a tablet computer.

4. The external electronic device according to claim 1, wherein the first transmission interface and the second transmission interface are universal serial bus (USB) ports.

5. The external electronic device according to claim 1, wherein the external electronic device further includes:
a state display connected to the switch module and displaying that the external electronic device is working at the power mode or the transfer mode.

6. The external electronic device according to claim 1, wherein the state display is a light emitting diode element.

7. The external electronic device according to claim 1, wherein the switch module includes a switch.

8. The external electronic device according to claim 1, wherein when the external electronic device is working at the power mode, a hard disk of the data control module is working at a standby mode.
